(19) United States
(12) Patent Application Publication
(10) Pub. No.: US 2026/0369498 A1
(43) Pub. Date: Nov. 19, 2026

(54) MAGNETIC LATCHING RELAY

(71) Applicant: XIAMEN HONGFA ELECTRIC POWER CONTROLS CO., LTD., Xiamen, Fujian (CN)

(72) Inventors: Wenguang DAI, Xiamen, Fujian (CN); Shuming ZHONG, Xiamen, Fujian (CN); Fangneng LI, Xiamen, Fujian (CN); Jianxin HU, Xiamen, Fujian (CN)

(21) Appl. No.: 19/582,943

(22) PCT Filed: Oct. 25, 2024
(86) PCT No.: PCT/CN2024/127420

§ 371 Date: Apr. 29, 2026

(30) Foreign Application Priority Data
Nov. 1, 2023 (CN) 202322960959.7

(51) Int. Cl. H01H 50/02; H01H 50/14

(52) U.S. Cl. CPC H01H 50/023; H01H 50/14

(57) ABSTRACT

A magnetic latching relay includes a bottom plate, a case, a first lead-out pin, a second lead-out pin, a coil lead-out pin, a magnetic circuit system and a contact system; the contact system uses a double-contact anti-short circuit structure; and the magnetic circuit system and the contact system are cladded in an internal space by the case and the bottom plate; the first lead-out pin, the second lead-out pin and the coil lead-out pin are led down through the bottom surface of the base, so as to facilitate a installation and wiring of an electromagnetic relay in a later stage, thereby facilitating the installation and use by the customer. Furthermore, the case is fitted to the base to form an enclosed space, thereby improving the protection of internal devices and improving the adaptability of the electromagnetic relay to a harsh external environment.

### CROSS-REFERENCE TO RELATED APPLICATIONS

This application is a national stage entry under 35 U.S.C. § 371 of International Application No. PCT/CN2024/127420, filed Oct. 25, 2024, which claims priority to Chinese Patent Application No. 202322960959.7, filed Nov. 1, 2023, the entire disclosures of which are hereby incorporated herein by reference.

### TECHNICAL FIELD

The present application relates to the field of switching devices, and in particular to a magnetic latching relay.

### BACKGROUND

As an electronic control device, a relay is used to control a large current using a small current. The relay is widely applied in automatic control circuits, and plays a role in automatic adjustment, safety protection, and conversion circuit in the circuits. A magnetic latching relay, as a kind of relay, is characterized in that open or closed states of contacts completely depend on an action of a permanent magnet. When the open or closed states of the contacts need to be switched, the switching can be completed only by exciting a coil using a pulse electric signal with a certain width, and then states of the contacts are latched by the permanent magnet. Therefore, the magnetic latching relay, as a low energy consumption component, has attracted more and more market attention.

At present, magnetic latching relay products have a direct current (DC) magnetic latching relay newly developed for DC meters in new energy industries, which is mainly used in the measurement of new energy DC charging piles. The original magnetic latching relay is applied to ordinary household electricity meters without sealing by dispensing, and lead-out pieces in an anti-short circuit structure thereof are led out from both sides, which is inconvenient for plastic packaging of products, and also inconvenient for customers to install. The existing magnetic latching relay is applied to the new energy DC charging piles, and the like, and an application environment thereof relatively harsh compared with the ordinary household electricity meters. If the structure of the existing magnetic latching relay is used, movable and stationary lead-out pieces are led out from a side wall of a base, and thus it cannot be sealed by dispensing.

### SUMMARY

Therefore, in view of the above problems, the present application provides a magnetic latching relay.

The present application is achieved by adopting the following solutions.

The present application provides a magnetic latching relay, including a case, a first lead-out pin, a second lead-out pin, a magnetic circuit system and a contact system, wherein the contact system is connected to the first lead-out pin and the second lead-out pin, the magnetic circuit system is configured to actuate the contact system to make the first lead-out pin and the second lead-out pin conducted or disconnected, the magnetic circuit system and the contact system are mounted on the base, the case is fitted to the base to form an internal space in the case and the base, and the magnetic circuit system and the contact system are cladded in the internal space by the case and the base, wherein the contact system uses an anti-short circuit structure, and the first lead-out pin and the second lead-out pin extend out of the internal space passing through a bottom plate of the base.

In one embodiment, the case includes a case side wall, the base includes a base side surface, wherein after the case is fitted to the base, the case side wall completely covers the base side surface, and a glue injecting groove is formed at a position of the case side wall adjoining a bottom surface of the base.

In one embodiment, the magnetic latching relay further comprises one or more coil lead-out pins, wherein the magnetic circuit system is connected to the coil lead-out pins, the coil lead-out pins extend downward out of the internal space passing through the bottom plate, and glue injecting grooves are formed around a periphery of the coil lead-out pins on the bottom plate.

In one embodiment, the bottom plate of the base is provided with two pin slots, and the first lead-out pin and the second lead-out pin respectively pass through the two pin slots and pass out of the two pin slots.

In one embodiment, glue injecting grooves are formed on the bottom plate around the first lead-out pin and the second lead-out pin, respectively.

In one embodiment, the contact system includes a first lead-out piece, a first movable spring, a second lead-out piece and a second movable spring, wherein the first lead-out piece and the second lead-out piece are fixedly mounted on the base, the first lead-out piece and the second lead-out piece are respectively connected to the first lead-out pin and the second lead-out pin, and the first movable spring and the second movable spring are arranged in parallel side by side, so that the first movable spring and the second movable spring form a parallel movable spring assembly; and the first lead-out piece is fixedly connected to an end of the first movable spring, the second lead-out piece is fixedly connected to an end of the second movable spring, and the first lead-out piece and the second lead-out piece are respectively located at different ends of the parallel movable spring assembly.

In one embodiment, the base is provided with a first mounting groove and a second mounting groove, wherein the first mounting groove is configured to mount the contact system, and the second mounting groove is configured to mount the magnetic circuit system; the first mounting groove and the second mounting groove are arranged side by side on the base; the first movable spring and the second movable spring are arranged in parallel side by side in the first mounting groove and are located at a side of the first mounting groove away from the second mounting groove, a bottom surface of the first mounting groove is provided with pin slots, and the pin slots are arranged at a side of the bottom surface of the first mounting groove away from the second mounting groove.

In one embodiment, the first movable spring includes a first fixed end and a first cantilevered end, and the first fixed end of the first movable spring is fixedly connected to the first lead-out piece; the second movable spring includes a second fixed end and a second cantilevered end, and the second fixed end of the second movable spring is fixedly connected to the second lead-out piece; the first fixed end of the first movable spring is opposite to the second cantilevered end of the second movable spring, and the first cantilevered end of the first movable spring is opposite to the second fixed end of the second movable spring; and the first fixed end and the second cantilevered end are respectively provided with a first stationary contact and a second movable contact oppositely arranged, and the second fixed end and the first cantilevered end are respectively provided with a second stationary contact and a first movable contact oppositely arranged.

In one embodiment, the magnetic circuit system includes a coil, an armature assembly, a first push card and a second push card, wherein the armature assembly is rotatably mounted on the base, a coil lead-out pin is connected to the coil, and the coil lead-out pin is led downward out passing through the bottom surface of the base; the first push card and the second push card are movably mounted on the base, and both ends of the armature assembly are respectively connected to one end of the first push card and one end of the second push card; and the other end of the first push card is connected to the first cantilevered end of the first movable spring, and the other end of the second push card is connected to the second cantilevered end of the second movable spring.

In one embodiment, the first lead-out piece and the second lead-out piece are integrally formed with the first lead-out pin and the second lead-out pin, respectively.

The technical solutions provided by the present application have the following technical effects.

1. The first lead-out pin, the second lead-out pin and the coil lead-out pin of the present application are led downward out passing through the bottom surface of the base, which can facilitate the installation and wiring of the electromagnetic relay in a later stage, thereby facilitating the installation and use of customers. Furthermore, the case is fitted to the base to form an enclosed space, thereby improving the protection of internal devices and improving the adaptability of the electromagnetic relay to a harsh external environment. In addition, the case and the base forms a closed structure, which makes the contact system using the anti-short circuit structure less affected by the harsh external environment, thereby improving the anti-short circuit performance of the contact system.

2. In the present application, after the case is fitted to the base, a sealing process can be performed by dispensing on the bottom surface of the base, thereby further improving the sealing performance of the electromagnetic relay and the adaptability to the external environment.

3. After the case is fitted to the base of the electromagnetic relay are mounted, the periphery of the pins is sealed by dispensing, thereby further improving the sealing performance of the electromagnetic relay and the adaptability to the external environment, and improving the insulation performance between the first lead-out pin and the second lead-out pin.

### BRIEF DESCRIPTION OF THE DRAWINGS

FIG. 1 is a perspective view of a magnetic latching relay.

FIG. 2 is a perspective view of a magnetic latching relay in a direction of a base.

FIG. 3 is a front view of a magnetic latching relay with a case removed.

FIG. 4 is a perspective view of a base.

FIG. 5 is a perspective view of a magnetic circuit system and a contact system.

FIG. 6 is a perspective view of a magnetic circuit system and a contact system in another direction.

### DETAILED DESCRIPTION

The technical solutions in the embodiments of the present application will be clearly and completely described below in conjunction with the accompanying drawings in the embodiments of the present application. Obviously, the described embodiments are only part of the embodiments of the present application, rather than all of them. Based on the embodiments in the present application, all other embodiments obtained by those skilled in the art without creative efforts shall fall within the scope of protection of the present application.

It should be understood that references throughout the specification to “one embodiment” or “an embodiment” mean that a particular feature, structure, or characteristic associated with the embodiment is included in at least one embodiment of the present application. Thus, appearances of “in one embodiment” or “in an embodiment” in various places throughout the specification are not necessarily all referring to the same embodiment. Furthermore, these particular features, structures, or characteristics may be combined in any suitable manner in one or more embodiments.

In order to further illustrate various embodiments, the present application provides accompanying drawings. These accompanying drawings, which constitute a part of the disclosed contents of the present application, are mainly used for illustrating the embodiments and explaining the operation principles of the embodiments together with the related description of the specification. Other possible embodiments and advantages of the present application will be understood by those skilled in the art with reference to these contents. Components in the drawings are not drawn to scale, and similar reference numerals of components are generally used to represent similar components.

The present application will now be further described in conjunction with the accompanying drawings and specific embodiments.

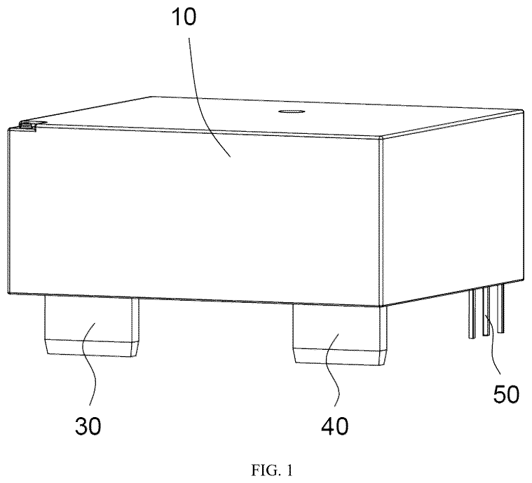

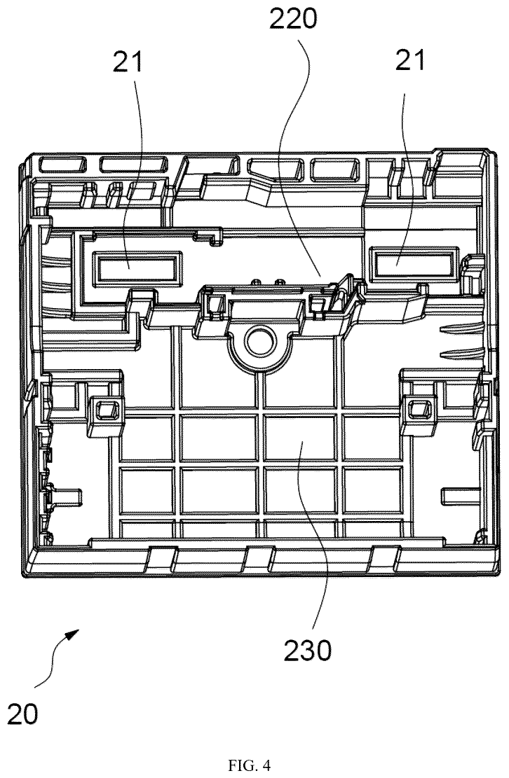

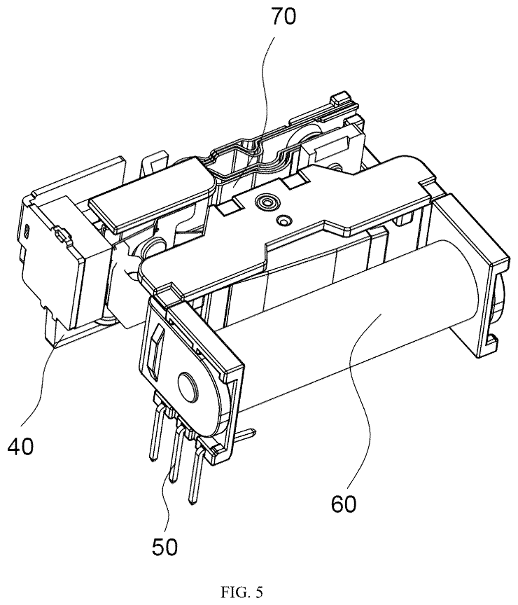

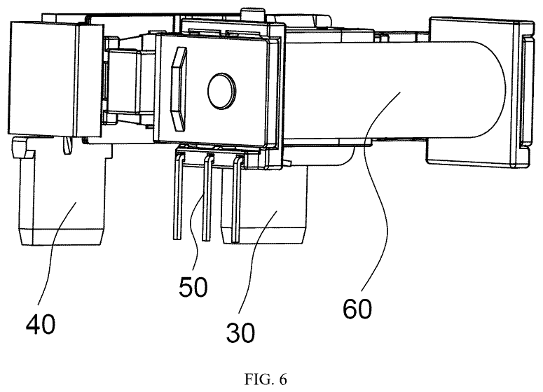

As shown in FIG. 1 to FIG. 6, the present application provides a magnetic latching relay, including a base 20, a case 10, a first lead-out pin 30, a second lead-out pin 40, one or more coil lead-out pins 50, a magnetic circuit system 60 and a contact system 70. The contact system 70 is connected to the first lead-out pin 30 and the second lead-out pin 40. The magnetic circuit system 60 is used to actuate the contact system 70, so that the contact system 70 can make the first lead-out pin 30 and the second lead-out pin 40 conducted or disconnected. The magnetic circuit system 60 is connected to the coil lead-out pin 50, and the coil lead-out pin 50 is used to connect a control circuit, so as to control the actuation of the magnetic circuit system 60 to the contact system 70. The magnetic circuit system 60 and the contact system 70 are mounted on the base 20. The case 10 is fitted to the base 20 to form an internal space in the case 10 and the base 20, and the magnetic circuit system 60 and the contact system 70 are cladded in the internal space by the case 10 and the base 20. The contact system 70 uses an anti-short circuit structure, the first lead-out pin 30, the second lead-out pin 40 and the coil lead-out pin 50 pass through a bottom surface of the base 20 to extend downwards out of the internal space. Among them, in this embodiment, the first lead-out pin 30 and the second lead-out pin 40 are sheet-shaped.

The first lead-out pin 30, the second lead-out pin 40 and the coil lead-out pin 50 are led downward out passing through the bottom surface of the base 20, which can facilitate the installation and wiring of the electromagnetic relay in a later stage, thereby facilitating the installation and use of customers. Moreover, after the first lead-out pin 30, the second lead-out pin 40 and the coil lead-out pin 50 are led downward out passing through the bottom surface of the base 20, the case 10 can be more conveniently fitted to the base 20 to form an enclosed space, thereby improving the protection of internal devices and improving the adaptability of the electromagnetic relay to a harsh external environment. In addition, the case 10 and the base 20 forms a closed structure, which makes the contact system 70 using the anti-short circuit structure less affected by the harsh external environment, thereby improving the anti-short circuit performance of the contact system 70.

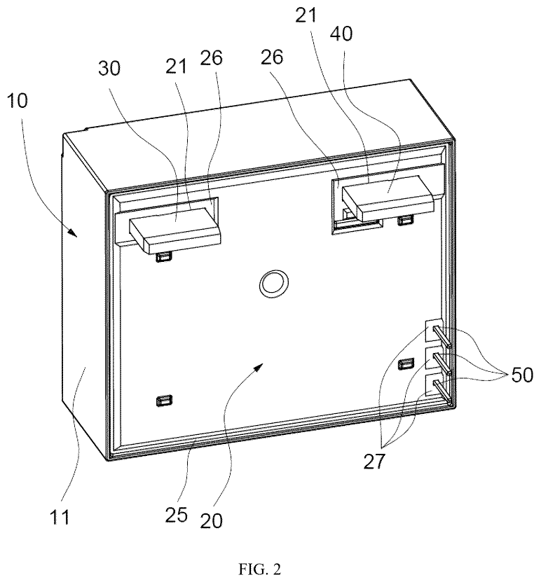

As shown in FIG. 1 to FIG. 3, the case 10 includes a case side wall 11, and the base 20 includes a base side surface 24. The case side wall 11 completely covers the base side surface 24 after the case 10 is fitted to base 20, and a glue injecting groove 25 is formed at a position of the case side wall 11 adjoining a bottom surface of the base 20, as shown in FIG. 2. The glue injecting groove is provided for sealing by dispensing between the bottom surface of the base 20 and the case side wall 11, thereby further improving the sealing performance of the electromagnetic relay and the adaptability to the external environment.

As shown in FIG. 2 to FIG. 4, two pin slots 21 are provided on the bottom plate of the base 20, and the first lead-out pin 30 and the second lead-out pin 40 respectively pass through the two pin slots 21 and then pass out of the two pin slots 21. Glue injecting grooves 26 are formed on the bottom plate around the first lead-out pin 30 and the second lead-out pin 40 respectively, as shown in FIG. 2. The glue injecting grooves are provided for sealing by dispensing between the first lead-out pin 30 and the pin slot 21, and between the second lead-out pin 40 and the pin slot 21, thereby further improving the sealing performance of the electromagnetic relay and the adaptability to the external environment, and improving the insulation performance between the first lead-out pin 30 and the second lead-out pin 40.

In addition, as shown in FIG. 2, glue injecting grooves 27 are also formed around a periphery of the coil lead-out pins 50 on the bottom plate of the base 20. The glue injecting grooves are provided for sealing by dispensing between the coil lead-out pins 50 and the bottom plate of the base 20, thereby further improving the sealing performance of the electromagnetic relay and the adaptability to the external environment, and improving the insulation performance between the coil lead-out pins 50.

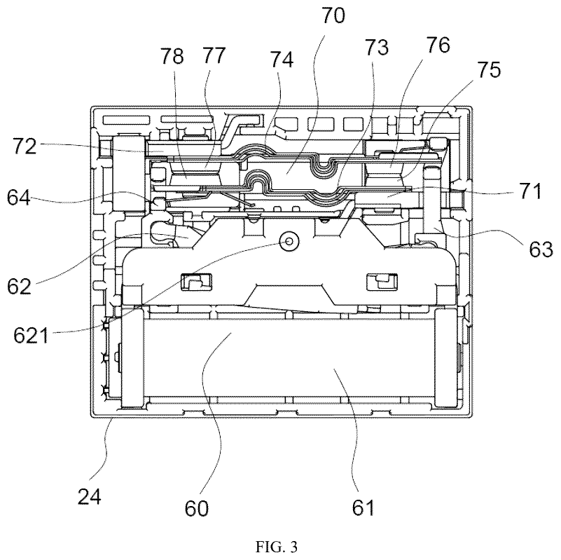

As shown in FIG. 3, the contact system 70 uses a double-contact anti-short circuit structure. Specifically, the contact system 70 includes a first lead-out piece 71, a first movable spring 73, a second lead-out piece 72 and a second movable spring 74. The first lead-out piece 71 and the second lead-out piece 72 are fixedly mounted on the base 20, and the first movable spring 73 and the second movable spring 74 are arranged in parallel on the base 20. The first lead-out piece 71 and the second lead-out piece 72 are respectively connected to the first lead-out pin 30 and the second lead-out pin 40. Optionally, the first lead-out piece 71 and the second lead-out piece 72 may be integrally formed with the first lead-out pin 30 and the second lead-out pin 40, respectively.

As shown in FIG. 2 to FIG. 4, the base 20 is provided with a first mounting groove 220 and a second mounting groove 230. The first mounting groove 220 is used for mounting the contact system 70, and the second mounting groove 230 is used for mounting the magnetic circuit system 60. The first mounting groove 220 and the second mounting groove 230 are arranged side by side on the base 20. The first movable spring 73 and the second movable spring 74 are arranged in parallel side by side in the first mounting groove 220 and located at a side, away from the second mounting groove 230, of the first mounting groove 220, and the first movable spring 73 and the second movable spring 74 constitute a parallel movable spring assembly. The bottom surface of the first mounting groove 220 is provided with pin slots 21, which are provided at a side, away from the second mounting groove 230, of the bottom surface of the first mounting groove 220. The first lead-out piece 71 is fixedly connected to one end of the first movable spring 73, the second lead-out piece 72 is fixedly connected to one end of the second movable spring 74, and the first lead-out piece 71 and the second lead-out piece 72 are respectively located at two different ends of the parallel movable spring assembly. Since the first movable spring 73 and the second movable spring 74 are arranged in parallel side by side in the first mounting groove 220, and the first lead-out piece 71 and the second lead-out piece 72 are respectively located at two different ends of the parallel movable spring assembly, the above-mentioned structure makes it easier for the first lead-out pin 30 and the second lead-out pin 40 connected to the first lead-out piece 71 and the second lead-out piece 72, respectively, to be arranged to be led downward out passing through the bottom surface of the base 20, so as to facilitate the mounting and wiring of the electromagnetic relay at a later stage, thereby facilitating the installation and use of customers. In addition, the sealing performance of the electromagnetic relay can be improved more conveniently.

As shown in FIG. 3, specifically, in the present embodiment, the first movable spring 73 includes a first fixed end and a first cantilevered end, and the first fixed end of the first movable spring 73 is fixedly connected to the first lead-out piece 71, so that the first movable spring 73 is in a cantilevered state. The second movable spring 74 includes a second fixed end and a second cantilevered end, and the second fixed end of the second movable spring 74 is fixedly connected to the second lead-out piece 72, so that the second movable spring 74 is in the cantilevered state. The first fixed end of the first movable spring 73 is opposite to the second cantilevered end of the second movable spring 74, and the first cantilevered end of the first movable spring 73 is opposite to the second fixed end of the second movable spring 74.

The first fixed end and the first cantilevered end of the first movable spring 73 are respectively provided with a first stationary contact 75 and a first movable contact 78, the second fixed end and the second cantilevered end of the second movable spring 74 are respectively provided with a second stationary contact 77 and a second movable contact 76, and the first stationary contact 75 and the second movable contact 76 are opposite to each other, and the first movable contact 78 and the second stationary contact 77 are opposite to each other. After the case 10 is fitted to the base 20, the sealing process is performed on the bottom surface of the base 20, thereby improving the sealing performance of the electromagnetic relay. The contact system 70 uses a double-contact anti-short circuit structure, which is less affected by the external environment, thereby further improving the overall anti-short circuit performance of the electromagnetic relay.

As shown in FIG. 3, the magnetic circuit system 60 includes a coil 61, an armature assembly 62, a first push card 63 and a second push card 64. The armature assembly 62 is rotatably mounted on the base 20, the coil 61 is connected to the coil lead-out pins 50, which are led downward out passing through the bottom surface of the base 20. The coil 61 is transversely mounted in the second mounting groove 230, so that the coil lead-out pin 50 is more easily provided to be led downward out passing through the bottom surface of the base 20. A permanent magnet is provided in the middle of the armature assembly 62, which can be actuated by the coil 61 with a variable polarity to rotate on the base 20. The first push card 63 and the second push card 64 are movably mounted on the base 20, and both ends of the armature assembly 62 are connected to one end of the first push card 63 and one end of the second push card 64, respectively, so that rotation of the armature assembly 62 causes the first push card 63 and the second push card 64 to move in opposite directions, respectively. The other end of the first push card 63 is connected to the first cantilevered end of the first movable spring 73, and the other end of the second push card 64 is connected to the second cantilevered end of the second movable spring 74, so that the movement of the first push card 63 and the second push card 64 respectively in opposite directions cause the two sets of movable and stationary contacts, namely the first stationary contact 75 and the second movable contact 76, as well as the first movable contact 78 and the second stationary contact 77, to be closed or open together.

The contact system 70 uses a double-contact anti-short circuit structure, compared with a single-contact structure, when a large current flows through a contact point, an electric force would be generated on a contact surface of the contact point, and this electric power would cause losses on a surface of the contact point and contact point adhesion, and in order to prevent the above-mentioned problems, when the double-contact anti-short circuit structure is used, when a large current flows through the contact point, the current is shunted at each contact of the double-contact so that the current passing through the single contact becomes smaller, and then the electric power generated at the contact surface of the contact point becomes smaller, so as to reduce the consumption of the contact point and prevent adhesion, and thus the double-contact structure is resistant to short circuit, while lightning stroke performance is better than that of the single-contact structure.

It should be noted that the various embodiments in the present specification are described in a progressive manner, each embodiment focuses on the differences from other embodiments, and the same and similar parts among the various embodiments may be referred to each other.

While optional embodiments of the embodiments of the present application have been described, those skilled in the art, once informed of the basic inventive concepts, may make additional changes and modifications to these embodiments. Therefore, the appended claims are intended to be construed to include the optional embodiments and all changes and modifications that fall within the scope of the embodiments of the present application.

The technical solutions provided by the present application have been described in detail above. Specific examples have been used herein to illustrate the principles and implementations of the present application. Meanwhile, those of ordinary skill in the art will, based on the principles and implementations of the present application, make changes in the specific implementation modes and application scopes. In conclusion, the contents of the present specification shall not be construed as limitations on the present application.

1. A magnetic latching relay, comprising a base, a case, a first lead-out pin, a second lead-out pin, a magnetic circuit system and a contact system, wherein the contact system is connected to the first lead-out pin and the second lead-out pin, the magnetic circuit system is configured to actuate the contact system to make the first lead-out pin and the second lead-out pin conducted or disconnected, the magnetic circuit system and the contact system are mounted on the base, the case is fitted to the base to form an internal space in the case and the base, and the magnetic circuit system and the contact system are cladded in the internal space by the case and the base, wherein the contact system uses an anti-short circuit structure, and the first lead-out pin and the second lead-out pin extend out of the internal space passing through a bottom plate of the base.

2. The magnetic latching relay according to claim 1, wherein the case comprises a case side wall, the base comprises a base side surface, wherein after the case is fitted to the base, the case side wall completely covers the base side surface, and a glue injecting groove is formed at a position of the case side wall adjoining a bottom surface of the base.

3. The magnetic latching relay according to claim 1, wherein the magnetic latching relay further comprises one or more coil lead-out pins, wherein the magnetic circuit system is connected to the coil lead-out pins, the coil lead-out pins extend downward out of the internal space passing through the bottom plate, and glue injecting grooves are formed around a periphery of the coil lead-out pins on the bottom plate.

4. The magnetic latching relay according to claim 1, wherein the bottom plate of the base is provided with two pin slots, and the first lead-out pin and the second lead-out pin respectively pass through the two pin slots and pass out of the two pin slots.

5. The magnetic latching relay according to claim 1, wherein glue injecting grooves are formed on the bottom plate around the first lead-out pin and the second lead-out pin, respectively.

6. The magnetic latching relay according to claim 1, wherein the contact system comprises a first lead-out piece, a first movable spring, a second lead-out piece and a second movable spring, wherein the first lead-out piece and the second lead-out piece are fixedly mounted on the base, the first lead-out piece and the second lead-out piece are respectively connected to the first lead-out pin and the second lead-out pin, and the first movable spring and the second movable spring are arranged in parallel side by side, so that the first movable spring and the second movable spring form a parallel movable spring assembly; and the first lead-out piece is fixedly connected to an end of the first movable spring, the second lead-out piece is fixedly connected to an end of the second movable spring, and the first lead-out piece and the second lead-out piece are respectively located at different ends of the parallel movable spring assembly.

7. The magnetic latching relay according to claim 6, wherein the base is provided with a first mounting groove and a second mounting groove, wherein the first mounting groove is configured to mount the contact system, and the second mounting groove is configured to mount the magnetic circuit system; the first mounting groove and the second mounting groove are arranged side by side on the base; the first movable spring and the second movable spring are arranged in parallel side by side in the first mounting groove and are located at a side of the first mounting groove away from the second mounting groove, a bottom surface of the first mounting groove is provided with pin slots, and the pin slots are arranged at a side of the bottom surface of the first mounting groove away from the second mounting groove.

8. The magnetic latching relay according to claim 6, wherein the first movable spring comprises a first fixed end and a first cantilevered end, and the first fixed end of the first movable spring is fixedly connected to the first lead-out piece; the second movable spring comprises a second fixed end and a second cantilevered end, and the second fixed end of the second movable spring is fixedly connected to the second lead-out piece; the first fixed end of the first movable spring is opposite to the second cantilevered end of the second movable spring, and the first cantilevered end of the first movable spring is opposite to the second fixed end of the second movable spring; and the first fixed end and the second cantilevered end are respectively provided with a first stationary contact and a second movable contact oppositely arranged, and the second fixed end and the first cantilevered end are respectively provided with a second stationary contact and a first movable contact oppositely arranged.

9. The magnetic latching relay according to claim 8, wherein the magnetic circuit system comprises a coil, an armature assembly, a first push card and a second push card, wherein the armature assembly is rotatably mounted on the base, a coil lead-out pin is connected to the coil, and the coil lead-out pin is led downward out passing through a bottom surface of the base; the first push card and the second push card are movably mounted on the base, and both ends of the armature assembly are respectively connected to one end of the first push card and one end of the second push card; and the other end of the first push card is connected to the first cantilevered end of the first movable spring, and the other end of the second push card is connected to the second cantilevered end of the second movable spring.

10. The magnetic latching relay according to claim 6, wherein the first lead-out piece and the second lead-out piece are integrally formed with the first lead-out pin and the second lead-out pin, respectively.

11. The magnetic latching relay according to claim 1, wherein the first lead-out pin and the second lead-out pin are sheet-shaped.

12. The magnetic latching relay according to claim 1, wherein the first lead-out pin and the second lead-out pin are led downward out passing through a bottom surface of the base, so that the case is fitted to the base to form an enclosed space.

13. The magnetic latching relay according to claim 1, wherein the contact system uses a double-contact anti-short circuit structure.

14. The magnetic latching relay according to claim 9, wherein the base is provided with a second mounting groove, and the coil is transversely mounted in the second mounting groove.

15. The magnetic latching relay according to claim 9, wherein a permanent magnet is provided in middle of the armature assembly, so that the armature assembly is capable of being actuated by the coil with a variable polarity to rotate on the base.

16. The magnetic latching relay according to claim 15, wherein rotation of the armature assembly causes the first push card and the second push card to move in opposite directions.

17. The magnetic latching relay according to claim 16, wherein movement of the first push card and the second push card in opposite directions cause the first stationary contact and the second movable contact, as well as the first movable contact and the second stationary contact, to be closed or open together.

18. The magnetic latching relay according to claim 2, wherein the glue injecting groove is provided for sealing by dispensing between the bottom surface of the base and the case side wall.

19. The magnetic latching relay according to claim 3, wherein the glue injecting grooves are provided for sealing by dispensing between the coil lead-out pins and the bottom plate of the base.

20. The magnetic latching relay according to claim 5, wherein the glue injecting grooves are provided for sealing by dispensing between the first lead-out pin and a pin slot, and between the second lead-out pin and the pin slot.
